(19) United States
(12) Patent Application Publication
(10) Pub. No.: US 2026/0291188 A1
(43) Pub. Date: Sep. 24, 2026

(54) MEDIUM VOLTAGE DIRECT BURIAL SPLICE DEVICE AND METHODS OF SPLICING POWER CABLE

(71) Applicant: MELNI, LLC, TWIN FALLS, ID (US)

(72) Inventors: CAMERON TROY WILLIAMS, TWIN FALLS, ID (US); MARK L. MELNI, TWIN FALLS, ID (US)

(21) Appl. No.: 19/546,329

(22) Filed: Feb. 21, 2026

Related U.S. Application Data
(60) Provisional application No. 63/761,508, filed on Feb. 21, 2025.

(51) Int. Cl. H02G 1/00

(52) U.S. Cl. CPC H02G 1/005

(57) ABSTRACT

A direct burial power cable connector/splice includes an inner/primary spiral system that splices conductors of two cables together and a coaxial outer/secondary spiral that is outside and around the inner spiral and splices the neutral wires/elements of the two cables. The primary-spiral-and-conductor combination and the secondary-spiral-and-neutral combination are separated by semiconductive materials for longevity and safety of the connection/splice. This semiconductive material may be one or more housing or endcap portions and is important in helping equalize the field current around the power conductor, and in ensuring electrical contact with the neutral or “earthing” system. High temperature silicone sealing components, injectable sealing materials, and/or RFID capability may be included in the connector/splice. These connectors/splices may utilize twisting/ratcheting technology to tighten the splices and will not only outperform traditional splice methods but have much faster installation times and far less workmanship-related errors.

This application claims benefit of Provisional Application Ser. No. 63/761,508, filed Feb. 21, 2025 and entitled MEDIUM VOLTAGE DIRECT BURIAL SPLICE DEVICE AND METHODS OF SPLICING POWER CABLE, the entire disclosure of which is incorporated herein by this reference.

### BACKGROUND

Applicant has recognized that splicing in underground medium voltage systems has problems in need of solutions. Traditional methods are costly, time consuming, and prone to assembly/installation mistakes. Workmanship-related errors alone make up more than 32% of all splice-related failures in Medium Voltage systems. Embodiments of the present splice device and/or methods of using the device solve multiple or all of these problems. Preferred embodiments of the splice device are simple, intuitive, and quick to install after minimal instruction, durable, and highly waterproof.

### SUMMARY

In certain embodiments, Applicant's splice device is well-adapted to be a medium voltage direct burial power cable connector (or “splice device” or “splice”). In certain other embodiments, one or more features disclosed herein may be applied to other cable/wire connections, for example, other voltage ranges, applications, or environments. Certain embodiments of the splice device utilize Applicant's innovative spiral-based wire connecting methods, innovative semiconductive material technology including the invented rigid injection-molded semiconductive housing(s) and/or endcaps, and optional but preferred high temperature silicone sealing components, injectable sealing materials, and/or RFID capability. Certain of these connectors/splices will not only outperform traditional splice methods but have much faster installation times and far less workmanship-related errors, for enhanced reliability, safety, and customer satisfaction.

Applicant herein discloses unique wire connecting device(s) that integrate strong, watertight and insulative mechanical housings with spiral-based splicing apparatus and methods. Certain embodiments feature spirals or spiral portions that, during installation on power cables, are moved from a relaxed condition/configuration to a tightened spiral condition/configuration having a smaller diameter than the relaxed spiral. Background spiral technology and operation methods relevant to certain embodiments of the presently disclosed invention(s) may be found in one or more of Applicant's patents, for example, U.S. Pat. Nos. 7,794,255, 7,901,233, 8,066,525, 8,246,370, 8,771,000, and 9,614,304, which patents are incorporated into this disclosure by this reference.

The presently preferred splice device embodiments comprise a spiral-within-a-spiral system, which is especially well-adapted to mechanically and electrically connect or “splice” a power cable having inner conductor(s) typically at the longitudinal centerline of the cable and neutral wires and/or neutral metallic shield (hereafter, also “neutral wires/shield”) that are coaxial/concentric with, but spaced apart from, the conductor(s). Power cables such as this are well known and may be purchased commercially, for example, 35 kV cables known as, or available from, STRANDFIL™ cables or LS CABLE AND SYSTEM™.

The presently preferred splice device embodiments comprise an inner or “primary” spiral, for example, an embodiment of a DUAL HELIX SPIRAL™ by Applicant, that connects or “splices” the conductors of two power cables. Said embodiments further comprise an outer or “secondary” spiral, also for example, an embodiment of a DUAL HELIX SPIRAL™ by Applicant. The primary spiral is electrically conductive and captures the conductors of the two cables to be in electrical contact/communication with each other, in some embodiments with the conductors directly touching each other inside the primary spiral or, in other embodiments with the conductors inside the spiral not directly touching each other.

The presently preferred secondary spiral is electrically conductive and mechanically and electrically connects the neutrals of the two cables, which in conventional power cables are wires or metallic shielding, to enable their purpose of being the neutral for the spliced cable. The neutrals of the two cables are typically longitudinally distanced from each other, providing room for connection of the conductors, so the neutrals inside the secondary spiral typically do not directly touch each other. The presently preferred secondary spiral has two spiral portions, one near each end of the secondary spiral separated by a non-spiraled middle portion, as the need for tightening the secondary spiral is substantially or entirely at the ends over the neutral wires/metallic shield.

It may be understood from the Drawings, that the preferred primary (inner) spiral and secondary (outer) spiral are coaxial/concentric, but of different lengths. Similarly, it may be understood from the Drawings that the primary and secondary spirals may be described as hollow and/or tubular, and the housings for the primary (inner) spiral and the secondary spiral may be described as hollow for receiving their respective spirals. Thus, in certain embodiments, the connector/splice device may be described as (starting from a central axis of the connector/splice device) the primary spiral being coaxial with and surrounded by its primary housing and/or endcaps, the primary housing and/or endcaps being coaxial with and surrounded by the secondary spiral, and the secondary spiral being coaxial with and surrounded by the secondary housing and/or endcaps.

In certain embodiments, the primary spiral extends axially through a primary spiral housing and out both ends of the primary housing to connect to primary endcaps, wherein the primary endcaps extend inward along the primary spiral housing to meet about midway along the length of the primary spiral. The primary spiral is axially shorter than the secondary spiral. The secondary spiral is concentric with the primary spiral, primary spiral housing, and primary spiral endcaps, and extends to connect to two secondary/outer sps that connect to the outer ends of a secondary/outer housing. For certain embodiments, the drawings may be interpreted as being drawn-to-scale and showing the relative dimensions of the splice device components. The presently preferred splice device embodiments comprise housings, ratcheting endcaps, sealing caps, O-rings and bushings that cooperate to allow primary spiral tightening and consequent capturing of the conductors inside the primary spiral, then tightening of the secondary spiral and consequent capturing of the neutrals inside the secondary spiral, and sealing of the splice device by use of the bushings and sealing caps around the cable to make the splice waterproof.

The primary-spiral-and-conductor combination and the secondary-spiral-and-neutral combination are separated by semiconductive materials (also “semi-con”), for longevity and safety of the connection/splice. This semiconductive material is particularly important for helping equalize the field current around the power conductor, and to ensure electrical contact with the neutral or “earthing” system. As discussed below in the section entitled SPECIALLY CONFIGURED SEMI-CON FEATURES, one or more housing(s) or endcap(s) of certain embodiments is/are formed of injection-molded semiconductive material while being sufficiently rigid to perform the mechanical requirements of the housing or endcap(s).

Certain embodiments of the disclosed splice device may comprise a port/aperture into the interior of the device, for injecting a sealing/waterproofing and/or “internal insulation” agent into the internal cavity of the device. For example, an epoxy, preferably a two-part dielectric epoxy, such as available from 3M®, may be forced through the port(s) in the outer housing and into the cavity, to form a water/airtight environment inside the device. After said injection, the port(s) sealed with a plug(s).

Certain embodiments may comprise an RFID device provided on the splice device, for example, embedded in or otherwise connected to the outer surface of the outer surface of the device, which is preferably the outer surface of the outer/secondary splice housing. The RFID may be used when the splice device is installed to splice/electrically-connect cables and buried underground, to report location of the splice and temperature of the device and any partial discharge conditions, to name a few of the benefits of this RFID reporting.

### Applicant's Spiral Technology:

Over years of research and design, Applicant has perfected various forms of spiral technologies. Applicant's spiral technology utilizes the natural physics and dynamics of a helix. During a performance test completed by UL (the cyclical pull test) Applicant's spiral-based connectors and traditional style crimps were cycled 10,000 times with both a weighted load and a constant applied current. Applicants' spiral connectors resulted in a change of resistance of less than 2% over the duration of the test. On the other hand, traditional style crimp connections see an average change of resistance from 40% to over 120%, resulting in catastrophic failure. A reason Applicant's technology performs so well is due to the spiral being a dynamic shape. Crimp-based connectors/connections remain static once the initial crimp is made, which means expansion and contraction of the conductor can only result in the crimp becoming looser over time and resistance becoming greater. On the other hand, Applicant's preferred spiral embodiments, called DUAL HELIX SPIRAL™, remain dynamic even after being compressed onto the conductor, thus resulting in the spiral's ability to expand and contract with the conductor as needed, maintaining a phenomenal connection and low resistance for extended periods of time.

Due to Applicant's spiral technology, the novel configuration and cooperation of elements that make up Applicant's preferred device, and the streamlined installation that the device enables, certain embodiments of Applicant's Medium Voltage Splice will decrease splice installation times by 4X by greatly reducing installation steps and processes. Simultaneously, this will reduce workmanship errors by over 40%. Applicant's Dual Helix Spiral™ has proven itself to have much longer service life by keeping resistance values low, thus resulting in service life increases of 10-15 years. All of these target metrics ultimately result in lower costs, both short term and long term and a more reliable and robust grid for the customers. These metrics are particularly important for the target market of the preferred medium voltage direct burial connector/splice as disclosed herein, which is primarily in the US coastal and high-risk states. The states highlighted in red in the Appendix see more than 50 outages annually. Applicant's splice technology can help retrofit these areas electrical grid underground in a more efficient and effective manner, bringing more reliable power to the customers quickly.

### Specially Adapted Semiconductive Features:

Certain embodiments of the splice device, and/or methods of manufacture and/or installation, comprise Applicant's inventive and unobvious discovery, incorporation, and use of a rigid semiconductive (“semi-con”) housing and/or endcaps in the present splice device. This way, in certain embodiments, the semi-con housing and/or endcaps serve as the entire or the major contributor of the semiconductive barrier inside the splice between conductors and neutral. In preferred embodiments, injection-moldable semiconductive material is molded to be the spiral housing, and/or the endcaps, that surround the primary spiral and that cooperate to rotate the two opposite ends of the primary spiral relative to each other to tighten the spiral on and around the conductors. This way, the housing and/or endcaps may serve both mechanical purpose(s) and a semiconductive purpose, being instrumental in the tightening of the primary spiral and in providing an excellent level of said “equalizing” of the field current around the conductors. Applicant has discovered that a commercially available semi-conductive plastic material, TECAPEEK ELS CF30 from Ensinger Inc, is effective for being injection-molded into the semi-con housing and/or endcaps for the primary splice assembly.

In certain embodiments, additional semiconductive material, such as a heat- or cold-shrink tube may be installed as a layer around the primary splice assembly. In preferred embodiments, such a shrink tube extends around the outside surface of the primary splice ratcheting endcaps that, in turn, extend along all the length of the primary splice housing and primary spiral that are contained within the endcaps.

### Certain Embodiments of Splicing/Installation Methods:

The preferred method of installing Applicant's Medium Voltage Connector/Splice Device is made possible, in part, by the coaxial nature of the connector/splice device and its spiral-within-a-spiral design. The splice/connection is started by preparing the two cable ends, if necessary, to expose the conductors and neutral wires/shield at the proper locations relative to the splice device components. For example, if necessary, the installer may quickly strip off portions (axial length portions) of the cable jacket, insulation, and/or shield layers that are typically provided as part of the cables, and/or the installer may quickly cut off a length of the neutral wires/shield to make them not extend over the conductor. See the exemplary cable on page 1 of Appendix that comprises wires as the neutral. However, it will be understood from this disclosure and commercially available power cables, that alternative cables that may be spliced by the disclosed splice device may comprise neutral concentric metallic shield in place of the neutral wires, for example, as shown on page 2 of the Appendix. Then, the desired location for an end of the splice device to reside after completion of the splice, based on proper alignment of the primary and secondary splice locations, is marked on the jacket of one of the cables as a reference point.

Proceeding from the above steps, the secondary assembly (SA shown exploded in Sheet 3), which is preferably assembled and shipped as a unit by the manufacturer, comprises the outer/secondary housing, outer/secondary ratchet endcaps and O-rings, the secondary spiral preinstalled in the housing and “locked” at its ends to the ratchet endcaps, and compression caps and compression bushings. For proceeding with the splice operation, one compression cap and its bushing are removed from the secondary assembly and slid onto one of the cables, and the rest of the secondary assembly, as a single unit, is slid onto the other of the cables.

Then, the primary splice begins by the installer inserting the conductors of the two cable ends into the primary splice assembly (PA in Sheets 3 and 5) that preferably has been previously assembled and shipped as a unit by the manufacturer. The primary splice assembly comprises the primary spiral inside the primary splice housing with the two spiral ends extending out of the primary splice housing far enough to each be locked inside a respective endcap via the spiral end hook systems (see Sheets 12-16). Said locking comprises preferably the manufacturer sliding the endcaps onto the spiral ends and then rotating the endcaps a few degrees to accomplish the engagement of endcap protrusions in the spiral end hooks (See Sheet 12).

Once the conductors are inserted into the ends of the primary splice assembly, the installer rotates the two primary splice endcaps in opposite directions to each other to tighten the primary spiral (reducing the spiral diameter) on the conductors to the desired extent. This may begin by hand-rotating the endcaps and may progress by torque-wrench to tighten the primary assembly to the specified torque, which is typically 25 lb-ft. This preferred torque is an example of the substantial forces being applied to the primary splice assembly to tighten the primary spiral, and also the need for the primary endcaps and primary housing to be rigid even when/if injection-molded from semiconductive plastic. The heat-shrink tube is then pulled over the primary assembly and heat- or cold-treated to shrink it properly on and around the primary assembly.

To proceed with the installation, the secondary splice components (for example, those held on both cables) are slid toward and over the primary splice assembly, the secondary ratcheting endcaps are used to tighten the secondary spiral (reducing the secondary spiral diameter), first by hand-tightening and then by torque wrench, again preferably with 25 lb-ft torque. The compression caps are screwed inward onto each end of the device, to tighten the bushings around the connected cables to make the ends of the connector/splice device waterproof.

Finally, epoxy or other waterproofing material is injected, through ports preferably near both ends of the outer housing, into the interior cavity of the connector/splice device as described above in this document. After it is apparent that the cavity is full of epoxy, for example, by epoxy running out of both ports, plugs are installed to block the ports.

As will be understood from the Drawings and this description, the two ends of each of the primary spiral and secondary spiral are engaged or “locked” into their respective ratcheting endcaps, via the spiral end hooks engagement with the interior surface/protrusion of the ratcheting caps, so that rotation of the endcaps causes the spiral ends to rotate with their respective cap. This way, when the two endcaps of a given spiral are rotated in opposite directions (their “tightening directions”) relative to each other, on the longitudinal axis of the connector/splice device, the ends of the spiral are rotated likewise, thus tightening the spiral to compress the conductors (in the case of the primary spiral) and to compress the neutrals (in the case of the secondary spiral). During the tightening, the ratchet elements of the endcaps slide along the ratchet elements of the primary housing. However, when the desire tightness is reached (lessening of the spiral diameter), the endcaps are released but the ratchet elements of the endcaps engage in the ratchet elements of the primary splice housing and the endcaps and housing cannot then rotate relative to each other in the opposite direction (as is understood from the term “ratcheting”). This ratchet system prevents the endcaps (and thereby the spiral ends locked into the endcaps via the hook and protrusion system) from rotating in the opposite relative directions (opposite the tightening directions) and thus prevents loosening of the primary spiral/splice.

Likewise, for example, the ratchet elements of the secondary splice ratchet caps engage (ratchet) with the ratchet elements of the outer/secondary housing, whereby this ratchet system allows the tightening of the secondary spiral around the neutral wires/shield, but prevents the ratchet caps (and thereby the spiral ends of the secondary spiral that are locked into the ratchet caps via the hook and protrusion system) from rotating in the opposite relative directions (opposite the tightening directions). Thus, in a manner similar to that of the primary splice assembly, the secondary ratchet system, once the secondary splice has been formed/tightened, between the secondary endcaps and housing prevents loosening of the secondary spiral/splice.

### BRIEF DESCRIPTION OF THE DRAWINGS AND APPENDIX

Referring to the Drawings, there are shown some, but not the only, embodiments of the splice device and its components, and of methods of installing cable ends in the device to accomplish a splice of two cables via a splice of the conductors of the cables and a splice of the neutrals of the cables. The conductors (22) and insulation (21) of the cables and their contact/compression by the primary spiral are easily seen in the cross-sectional drawings that include the cables installed in the connector/splice device. The zone NZ where the neutral wires are contacted/compressed by the secondary spiral is seen and labeled as NZ in several of the cross-sectional drawings but the neutrals (neutral wires NW) are drawn and best visible in the enlargement of FIG. 12.

FIG. 1 is a side view of one embodiment of the assembled connector/splice device (also called simply “Splice”), especially adapted for direct burial underground, and excellent waterproof, durable, and long operation in that challenging environment. In this view, no cables are installed/spliced in the device.

FIGS. 2 and 3 are side views of the components of the splice device of FIG. 1.

FIG. 2 shows the fully assembled primary splice assembly (PA). The primary splice housing and the primary spiral are not visible in this view, as they are inside two ratcheting endcaps. The individual components of the primary splice assembly are shown in FIGS. 6 and 7 and further detailed in FIGS. 16-32, and a cross-section of the fully assembled primary splice assembly (PA), with all components visible, is provided in FIG. 33.

FIG. 3 is a side view of the secondary spiral assembly (SA), with the secondary spiral removed from the secondary housing and shown below the housing, and the other components of the secondary spiral assembly (endcaps, seals, bushings, and compression caps) exploded out to the right and left of the housing. The individual components of the secondary spiral assembly (SA) are further detailed in FIGS. 34-54, and cross-sectional and end views of the assembled primary splice assembly (PA), without the primary assembly or a semiconducting, insulating heat shrink layer/tube, are provided in FIGS. 55-57.

FIG. 4 is an enlarged view of the primary splice assembly of FIG. 2.

FIG. 5 is an end view of the primary splice assembly of FIG. 4.

FIG. 6 is an exploded side view of the primary splice assembly body/housing, endcaps, and orings of FIG. 4.

FIG. 7 is a side view of the primary splice spiral of FIG. 4, removed from the housing and endcaps of FIG. 6.

FIG. 8 is a longitudinal cross-section of the right-half of the connector/splice device of FIG. 1, still without any cable installed in the device. This view shows the combination of the primary splice assembly (PA) installed inside the secondary splice assembly (SA), forming the fully assembled connector/splice device C, while the primary splice assembly (PA), and the secondary splice assembly (SA), are each shown separately from each other in the cross-sectional views of FIG. 33 and FIGS. 40-42, respectively.

FIG. 9 a side view of the connector/splice device of FIG. 1, now with two cables installed and spliced inside the device.

FIG. 10 is a longitudinal cross-section of the device including installed cables of FIG. 9.

FIG. 11 is the right half of the longitudinal cross-section of FIG. 10 (surrounded by a rectangular box in FIG. 10), enlarged for better viewing.

FIG. 12 is a further enlargement of the right half cross-sectional view of FIG. 10, much like that in FIG. 11, except that the neutral wires NW and their relationship to the secondary spiral are clearly visible in the neutral zone NZ. Exemplary power cables and their conductor and neutral wire/shield locations are also shown in the Appendix.

FIG. 13 is a closeup view of the right-most region, inside the box labeled FIG. 13, of the device of FIG. 11.

FIG. 14 is a closeup view of the middle region, inside the box labeled FIG. 14, of the device of FIG. 11.

FIG. 15 is a closeup view of the left-most region, inside the box labeled FIG. 15, of the device of FIG. 11.

FIG. 16 is a side perspective view of the primary spiral of FIG. 7, which is inside the primary splice assembly of FIG. 2.

FIG. 17 is a side view of the primary spiral of FIG. 16, with the spiral cut portions “extending around the back” of the primary spiral shown in dashed lines.

FIG. 18 is an end view of the primary spiral of FIGS. 16 and 17.

FIG. 19 is an enlarged view of the end portion circled in FIG. 16, which is described later in this document as a “spiral hook system”.

FIG. 20 is a side perspective view of the primary splice assembly body/housing (11) of FIG. 6.

FIG. 21 is a side view of the primary splice assembly body/housing of FIG. 20.

FIG. 22 is an end view of the body/housing of FIG. 21.

FIG. 23 is a longitudinal cross-section of the body/housing of FIGS. 20-22, viewed according to the cross-section line in FIG. 22.

FIG. 24 is an end view of FIG. 21 wherein the external ratchet teeth of the spiral end are visible.

FIG. 25 is an enlargement of the detail, circled in FIG. 24, that shows a portion of the external ratchet teeth of the body/housing of FIGS. 20-24.

FIG. 26 is a side perspective view of one of the primary splice endcaps, namely the left endcap of FIGS. 2, 4, and 6 but noting that the left and right endcaps of certain embodiments may be mirror images of each other.

FIG. 27 is an end view of the endcap of FIG. 26.

FIG. 28 is a longitudinal cross-sectional view of the endcap of FIG. 26, viewed along the cross-sectional line in FIG. 27.

FIG. 29 is a side view of the endcap of FIGS. 26-28 including radial cross-sectional lines.

FIG. 30 is a cross-sectional view of the endcap of FIG. 29 viewed along the cross-sectional line labeled FIG. 30, wherein this cross-section is through the internal ratcheted portion of the endcap that cooperates with the external ratchet teeth of the body/housing of FIGS. 20 and 25, but also shows the internal protrusions that cooperate with the spiral hook system of the primary spiral that is shown in FIGS. 16 and 19.

FIG. 31 is a cross-sectional view of the endcap of FIG. 29 viewed along the cross-sectional line labeled FIG. 31, wherein this cross section is through the interior protrusions portion of the endcap that cooperates with the primary spiral hook system of FIGS. 16 and 19.

FIG. 32 is an enlargement of the detail, circled in FIG. 30, that shows a portion of the interior ratchet teeth of endcap of FIG. 29.

FIG. 33 is a longitudinal cross-sectional view of the primary splice assembly of FIGS. 2 and 4.

FIG. 34 is a perspective view of the secondary spiral of FIG. 3.

FIG. 35 is a side view of the secondary spiral of FIG. 34.

FIG. 36 is an enlarged detail of an end of the secondary spiral that is circled in

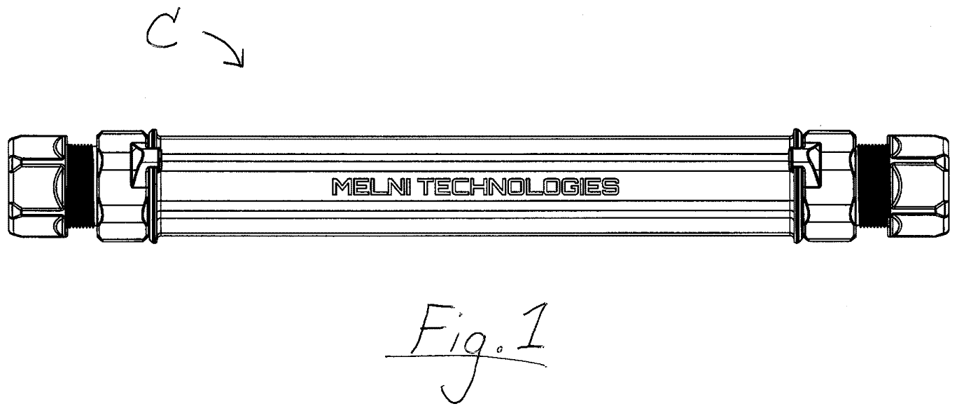

FIG. 35.

FIG. 37 is a side view of the secondary spiral of FIG. 3, with the spiral cut portions “extending around the back” of the secondary spiral shown in dashed lines.

FIG. 38 is an enlarged detail of the spiral cut region that is circled in FIG. 37.

FIG. 39 is an enlarged detail of a spiral cut end that is circled in FIG. 38.

FIG. 40 is a side view of the outer/secondary housing of the secondary spiral assembly of FIG. 3

FIG. 41 is a longitudinal cross-section of the housing of FIG. 40.

FIG. 42 is a side view of one of the ratcheting endcaps of the secondary spiral assembly of FIG. 3.

FIG. 43 is a longitudinal cross-section of the endcap of FIG. 42, viewed along the line in FIG. 44.

FIG. 44 is an end view of the endcap of FIG. 42.

FIG. 45 is an enlarged detail of the endcap hook circled in FIG. 43.

FIG. 46 is an end view of the endcap of FIG. 42.

FIG. 47 is an enlarged end view of the endcap hook circled in FIG. 46.

FIG. 48 is a portion of the endcap end view of FIG. 46.

FIG. 49 is an enlarged detail of a protrusion of the endcap of FIGS. 42 and 43 that is circled in FIG. 48.

FIG. 50 is an enlarged detail of ratchet teeth of the endcap of FIGS. 42 and 43 that is circled in FIG. 48.

FIG. 51 is a perspective view of an compression cap of the secondary splice assembly of FIG. 3.

FIG. 52 is a side view of the compression cap of FIG. 51.

FIG. 53 is a cross-sectional view of the compression cap of FIG. 51 viewed along the line in FIG. 54.

FIG. 54 is an end view of the compression cap of FIG. 51.

FIG. 55 is a longitudinal cross-sectional view of the secondary splice assembly of FIG. 3 when fully assembled and not exploded, viewed along the line in FIG. 56.

FIG. 56 is an end view of the secondary splice assembly of FIG. 55.

FIG. 57 is an enlarged view of a portion of the secondary splice assembly that is inside the rectangular box in FIG. 55.

FIG. 58 is a side view of an exemplary insulating/semiconducting shrink tube that may be used, in certain embodiments of the splice device, over the primary splice assembly and certain portions of adjacent elements.

The Appendix to the Specification includes drawings of some exemplary power cables that may be used in certain embodiments, and further information in slide-format about certain embodiments, of Applicant's splice device and methods.

### FURTHER DISCUSSION OF CERTAIN EMBODIMENTS PORTRAYED IN THE DRAWINGS

From viewing the Drawings and the Appendix, it will be clear to those of skill in the art that Applicant's splice device and methods are novel and unobvious in view of the complex, difficult to install, and prone-to-defects/failure conventional splicing equipment. In addition, as discussed above, a particularly important feature of certain embodiments of Applicant's splice device comprises a surprising selection of material and associated surprising results of enhanced durability, safety, and longevity in the difficult environment in which a medium voltage direct burial splice resides, hopefully for years.

When splicing medium voltage cables greater than 5 kV, it is critical to create a uniform electric field within the insulation layers. This reduces the concentrations of electrical stresses that damage the insulative layers, thus improving reliability and longevity of the splice and cable system. In all conventional medium voltage splicing systems, this is accomplished by wrapping a uniform layer of semiconducting material onto and around the primary current carrying components, this being called conventionally “a compression splice”. Conventionally, this semi-con layer is either a flexible tape that is wrapped directly on and around the primary current carrying components, or a flexible cold- or heat-shrink tube that is “shrunk” directly onto the primary current carrying components.

On the other hand, Applicant's inventive splice design uses one or more mechanical housing(s) around a conductive spiral, wherein the mechanical housing(s) are used in the tightening of the spiral around the primary current carrying components, so it is not possible to install a semi-con layer in the same manner as the conventional state of the art. For Applicant's splice to accomplish the necessary layering design for electrical field stress control, Applicant manufactures at least one of the mechanical housing components, which surround(s) the Dual Helix Spiral that contacts the primary conductors, from a semiconducting material. Applicant has found that using an injection-moldable semiconducting plastic to form housing(s) that cover and serve a role in operating the spiral, results in a system possessing both the electrical and mechanical properties needed. A further benefit of this method is that Applicant can control, by virtue of injection-molding of rigid semi-con housing(s), the uniformity and concentricity of the componentry design, eliminating stress concentration points that have the potential to exist in traditional splicing methods by workmanship error alone and that can increase, and that damage the insulative layers. Thus, the housing(s) that importantly serve(s) one or more roles in the operation of mechanically splicing the primary conductors, also serves a semiconductive purpose, improving reliability and longevity of the splice and cable system.

In certain embodiments, there are two types of components in the primary assembly that house and operate the primary splice, namely, the housing body and preferably two ratcheting endcaps. In some embodiments, all of these three elements are injection-molded of semiconductive plastic. It is noteworthy that the primary splice endcaps surrounding the primary spiral are, combined, longer than the primary spiral, which provides what may be considered an additional housing around the entire spiral to contribute additional stability and durability, and in certain embodiments wherein the endcaps are semiconductive, to provide additional semiconductive layer benefits.

In certain alternative embodiments, only the primary splice housing body is molded out of the semiconducting plastic, as this may avoid an electrically conductive overlap between semiconductive ratcheting endcaps and the cable insulation shield that is also semiconductive. As the semiconductive components will become charged by partial discharge, it is critical in most embodiments that the semiconductive components are separated by insulating layers, to prevent early voltage breakout failure. To do this, it is expected that especially preferred embodiments will feature injection-molding of the primary splice housing from semiconductive plastic, but injection-molding of the ratcheting endcaps from insulator rather than semiconductor plastic/material, which will beneficially separate the live semiconducting body from the semiconducting insulation shield of the cable.

### REFERENCE NUMBERS

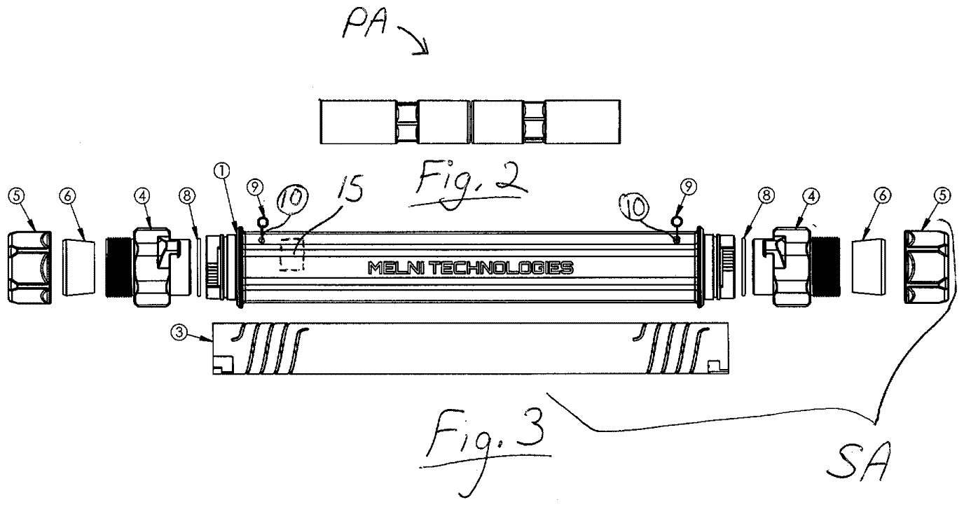

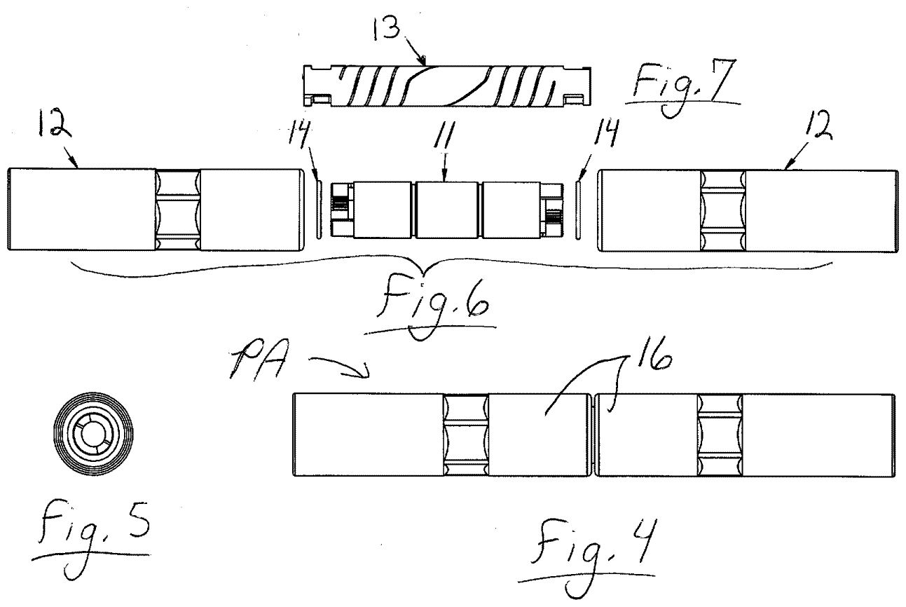

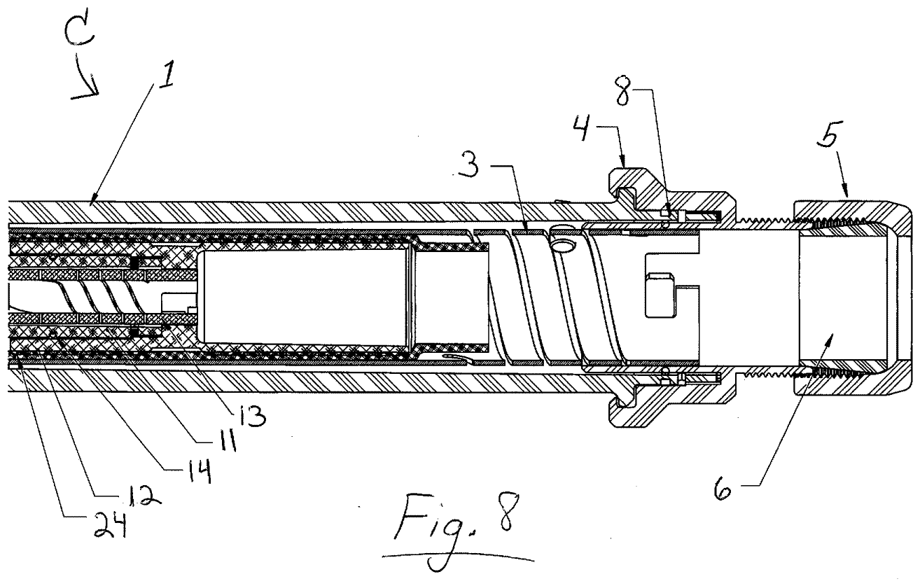

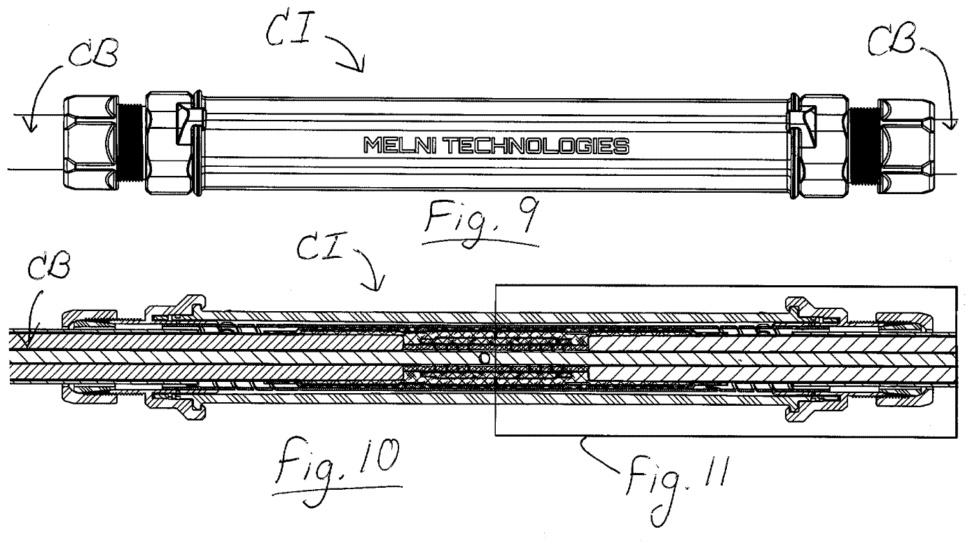

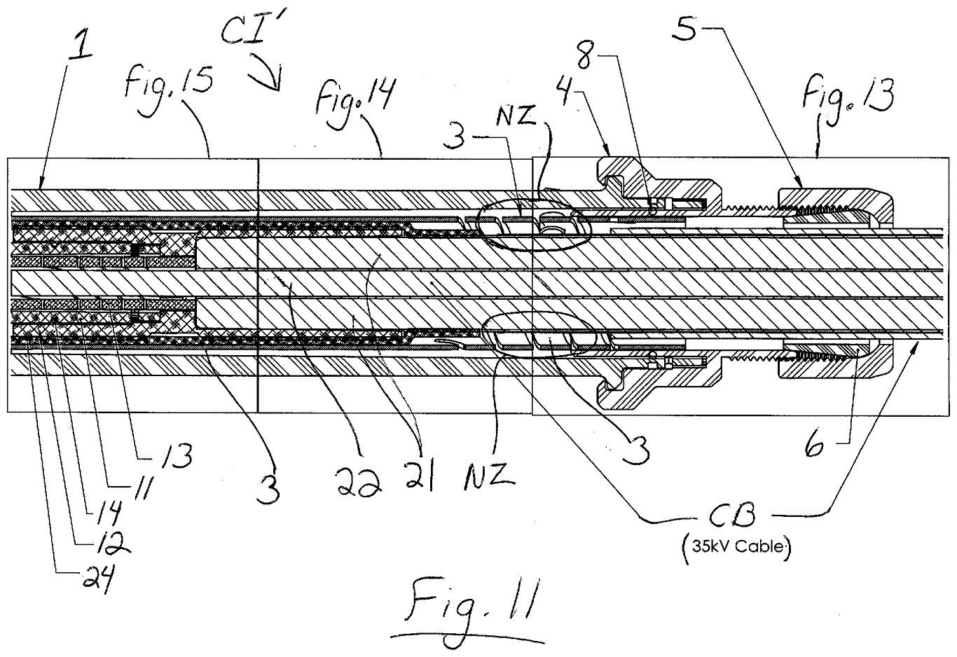

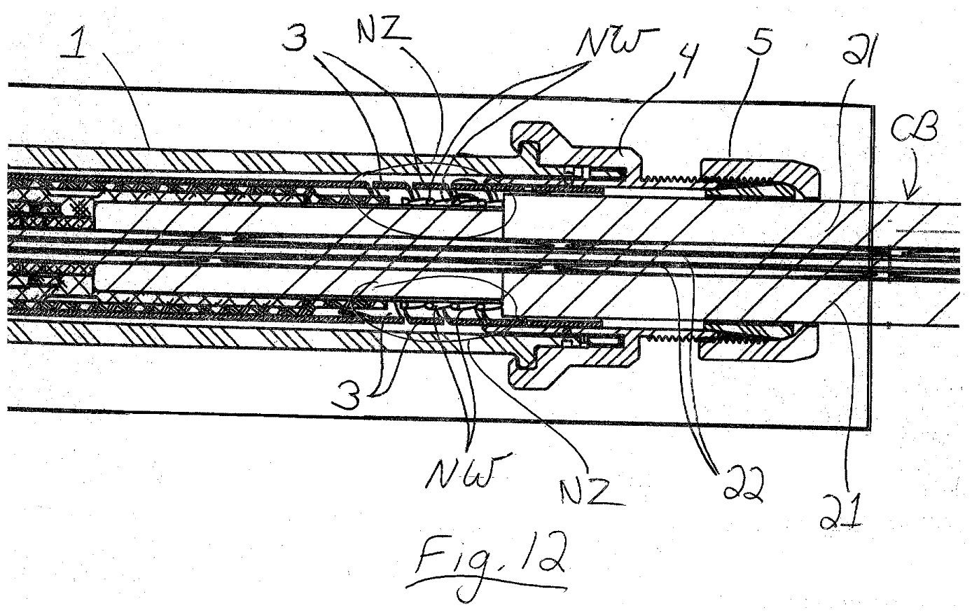

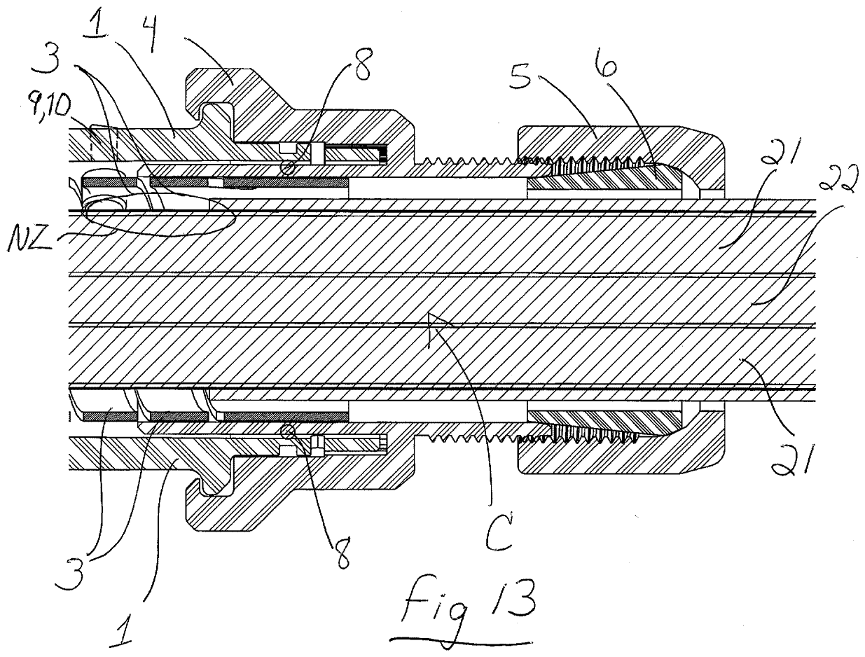

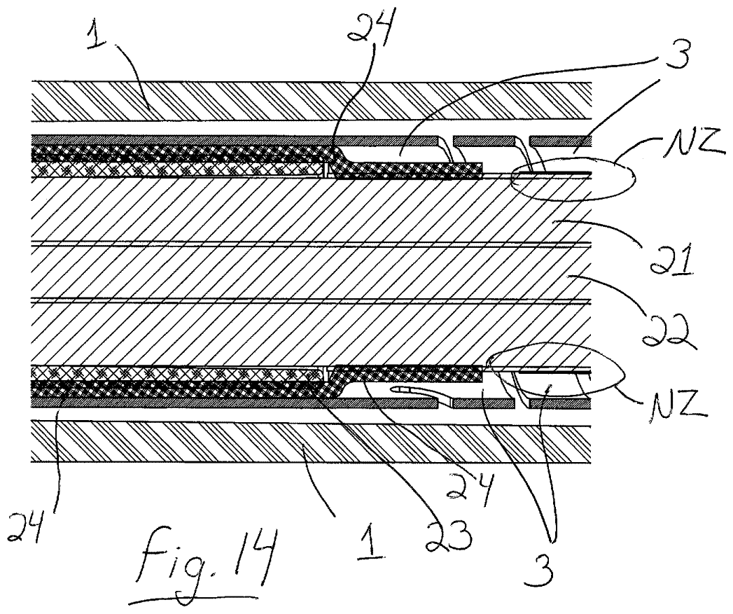

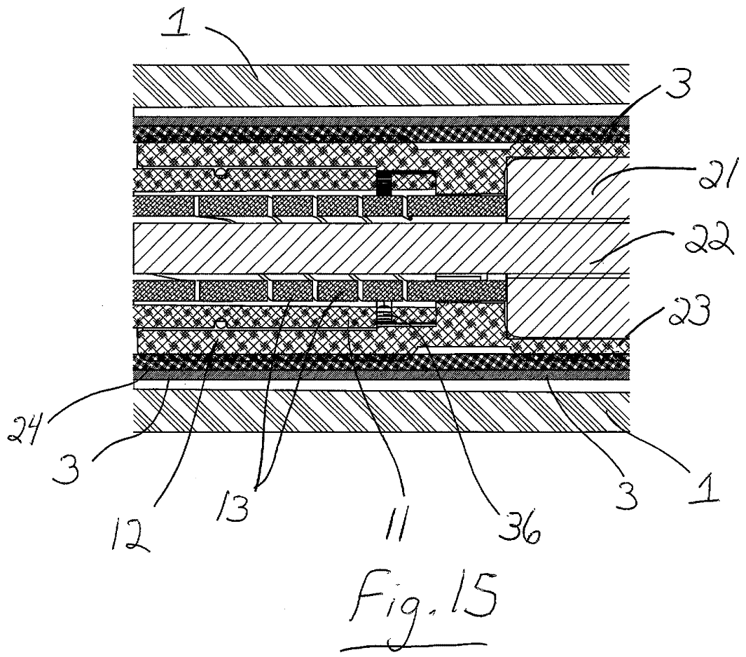

C: Assembled Connector/Splice Device, without cable, aka “DIRECT BURIAL SPLICE DEVICE”;
PA: Inner/Primary Splice Assembly, aka “Primary Assembly”, shown in FIGS. 2 and 4 (assembled), and in FIGS. 6 and 7 (disassembled/exploded), and assembled and in cross-section, without the cable, wherein the left and right ends/halves of this primary splice assembly embodiment are mirror images of each other;
SA: Outer/Secondary Splice Assembly or “Secondary Assembly”, shown in FIG. 3 (exploded) and in FIGS. 55-57 (assembled), without the primary splice assembly and cable, wherein the left and right ends/halves of this secondary assembly embodiment are mirror images of each other;
1: Outer/Secondary Splice Body, aka “outer/secondary housing” or “secondary splice outer housing”;
3: Outer/Secondary Dual Helix Spiral, aka “secondary splice spiral”, which is longer than the inner/primary spiral to reach outward (away from the center of the Splice Device/Connector) to electrically connect to the cable's neutral(s), at neutral connection zone NZ (see neutral wires NW in zone NZ of FIG. 12);
4: Secondary Splice ratcheting Endcap;
5: Secondary Splice Compression Cap (aka “Secondary Splice Sealing Cap”) to seal the splice device/connector around cable, threadably connected to endcap 4 to compress bushing 6 against the cable;
6: Secondary Splice Compression Bushing aka “Compression Sealing Gland”;
8: Secondary Splice Outer Oring;
9: Secondary Splice Epoxy Port Plugs, shown schematically, to be inserted into ports 10 (see FIGS. 3 and 13);
10 Epoxy Ports, for receiving Dielectric Two Part Epoxy into interior of the Splice Device/Connector C;
11: Primary Splice Body, also called “primary housing”;
12: Primary Splice Ratcheting Cap aka “Ratcheting Endcap” (may be two mirror image endcaps);
13: Primary Splice Dual Helix Spiral;
14: Primary Splice Oring;
15: RFID device on/in Outer/Secondary Splice Body/Housing
16: Endcap assembly, which is the combination of right and left endcaps;
CI: Full Connector Assembly with Installed Cable;
CI′: A Portion/Section of Full Connector Assembly with Installed Cable;
CB: Cable;
NW: Neutral wires or shield compressed/captured by Outer/Secondary Spiral 3, FIG. 12, also called simply “neutral”;
21: Cable Insulation;
22: Cable Conductor;
23 Outer end of primary splice ratcheting cap;
24 Semiconducting insulating heat shrink, for example, a two-layer; insulating/semiconducting shrink tube, and/or Heatshrink/SemiCon (for example, QDWT-36/12-01-QB1000MM), via hot or cold shrink, may be applied over and around Primary Splice Assembly;
27: Compression sealing gland;
28: Spiral hook system for locking to endcaps by means of engagement with inwardly extending endcap protrusions, wherein the spiral ends extend longitudinally out past the primary splice body to engage with the endcap protrusions. For example, the hook system at each end of the spiral locks to the interior of a respective ratcheting endcap;
RE1: Ratcheting engagement zone, cooperation between endcaps 12 and primary splice body/housing 11 to tighten spiral 13;
29: Hook system “L-shaped” space of the primary splice spiral hook system 28, so the hook system slides 28 over the endcap protrusion 30 and then rotates on the longitudinal axis of the spiral, so each (opposing) spiral end 28 locks to the respective endcap protrusion 30;
30: Interior Protrusions on endcap for cooperating with spiral-end hook system (for example, 180° apart) to slide into and rotate relative to hook L-shaped space 29 at end of primary spiral 13 to lock spiral end to endcap;
31: Hook ends of hook system 28;
32: Axial passageway of primary splice assembly, see FIG. 33;
33 Spiral cuts in primary spiral, see FIGS. 16 and 17;
34: Interior ratchet element for cooperation with exterior ratchet element 36 of primary splice body;
36: Exterior Ratchet elements on each end of primary splice body/housing 11, for latching to interior ratchet elements 34 of the endcaps 12;
38: Spiral cuts in the outer/secondary spiral, see FIGS. 35, 37 and 38;
40: Spiral portions of outer/secondary spiral, comprising spiral cuts 38, spaced apart from each other to be over/around neutral wires to tighten over/compress the neutral wires;
41: Central portion of outer/secondary spiral, which preferably has no spiral cuts;
42: Outer/Secondary spiral hook system;
44: Outer/Secondary spiral hook system hook ends;
52: Ratchet elements of outer/secondary housing 1;
53: Ratchet elements of secondary endcap 4;
54: Outer/secondary endcap protrusion, which extends inward to engage hook system 42 via hook end 44 of outer/secondary spiral;
55: Axial passageway of secondary splice assembly, see FIG. 57;
RE2: Ratcheting engagement zones, at opposite ends (mirror image ends, in preferred embodiment) of the outer/secondary splice assembly SA, comprising cooperation between endcaps 4 and outer/secondary splice body/housing 1 to tighten spiral 3;
56 Space into which outer housing end extends for ratcheting engagement with outer housing endcap; and
58: Hook on ratcheting endcap for cooperating/locking to the outer/secondary splice body/housing.

### Further Description of Certain Embodiments

1) Certain embodiments of the invention may be described as a splice device for slicing two cables, such as jacketed concentric neutral power cables, namely a right and a left cable, each cable comprising a conductor and neutral wire(s), the splice device comprising, consisting essentially of, or consisting of:
A primary splice assembly having an axial passageway having a right opening and a left opening and receiving the conductor of the right cable in the right opening and receiving the left cable in the left opening, so that the primary splice assembly is coaxial with the cables and their conductors;
The primary splice assembly comprising an electrically-conductive primary spiral that surrounds the axial passageway and the conductors that are received in the axial passageway, the spiral being tightenable around the conductors to compress the conductors to place the conductors of the two cables in electrical connection/communication with the primary spiral and therefor with each other;
A secondary splice assembly that has a secondary passageway receiving the primary splice assembly, so that the secondary splice assembly is coaxial with the primary splice assembly and the two cables, the secondary splice assembly having a secondary spiral inside the secondary passageway that has at least a right spiral portion and a left spiral portion that are tightenable to compress the neutral wire(s) of the right and the left cables, the secondary spiral being adapted to place the neutral wire(s) of the two cables in electrical connection/communication with the secondary spiral and therefore with each other;
Wherein said primary splice assembly comprises a housing around the primary spiral and extending substantially along (at least 80%, or more preferably at least 90%, or 80-98 percent) the entire length of the primary spiral, and two endcaps that engage right and left ends of the primary spiral and also engage the housing, with the endcaps extending all along the length of the housing and the primary spiral, wherein rotating the two endcaps in opposite directions rotate the right and left ends of the primary spiral to tighten the primary spiral around the conductors, and wherein said housing is rigid and formed of injection-molded semi-conductive material/plastic so the housing is a semi-conductive layer between the primary spiral and the endcaps, wherein the housing may extend along at least 80% or at least 90% of the primary spiral length, or in preferred embodiments the housing extends along 80% to 98% of the primary spiral length so that the housing is shorter than the primary spiral so that ends of the spiral extend axially out past the housing to engage the end caps.
2) Certain embodiments as in no. 1 above comprising sealing components provided in the secondary splice assembly for sealing ends of the secondary splice assembly against the two cables for making the splice device waterproof so that water, moisture, and air/gasses do not enter into the interior cavity of the splice device.
3) Certain embodiments as in no. 1 above comprising ports through an outer housing of the secondary splice assembly through which epoxy is injected to form additional waterproofing for the interior of the splice device.
4) Certain embodiments of no. 1 or 2 or 3 above comprising a RFID device installed on/in the outer surface of the splice device for monitoring the device location and condition.
5). Certain embodiments of the invention comprising, consisting essentially of, or consisting of: a method of installing a splice device (for example, but necessarily limited to, the splice device of any of no. 1-4), wherein the primary splice assembly is tubular and the secondary splice assembly is tubular and the secondary splice assembly is slid onto one of the cables prior to the conductors being inserted into the open ends of the primary splice device, whereafter the primary spiral is tightened by twisting endcaps in opposite directions to twist the primary spiral ends in opposite directions to tighten the spiral on the conductors, and

Then sliding the secondary splice assembly over the primary splice assembly and twisting endcaps of the secondary splice assembly so the secondary spiral (or portions thereof) tighten around neutral wire(s) of the two cables.
6) Certain embodiments of no. 5 wherein the method step of sliding the secondary splice assembly onto a cable (for example, the left cable) comprises first removing an end-sealing unit (for example, a bushing/seal and a compression cap) from the secondary splice assembly and sliding the end-sealing unit onto the other cable (for example, the right cable), prior to performing the primary splice with the primary splice assembly, and then, after performing the primary splice, sliding the end-sealing unit toward the primary splice and installing the end-sealing unit on the secondary splice assembly that has been slid over the primary splice assembly to seal an end of the splice device against the right cable.
7) Certain embodiments of no. 6 above, wherein the secondary splice assembly has a left end-sealing unit, and wherein, after the secondary splice assembly is slid toward and over the primary splice assembly, the left end-sealing unit is installed to seal the left end of the splice device against the left cable.
8) Certain embodiments of 6 of 7, wherein the only sealing between the secondary splice assembly right and left ends is the bushing/seal and compression cap compressing the bushing/seal against the outer jackets of the two cablese.
9) Certain embodiments of any of the numbered sections above, wherein the endcaps of the primary splice assembly are rigid and formed of injection-molded semi-conductive material/plastic.
10) Certain embodiments of any of the numbered sections above, wherein the endcaps and/or the housing of the primary splice assembly are rigid and formed of injection-molded semi-conductive material/plastic and so perform a mechanical operation in tightening the primary spiral and also a semiconductive operation to eliminate stress concentration points that have the potential to exist in traditional splicing methods by workmanship error alone and that can increase, and that damage the insulative layers.
11) Certain embodiments of any of the numbered sections above, wherein the splice device does not include tape wrapping around the conductors.
12) Certain embodiments of any of the numbered sections above, wherein the splice device does not include tape wrapping around the neutral wires/shield.
13) Certain embodiments of any of the numbered sections above, wherein a primary spiral housing extends along a substantial, but not the entire, length of the primary spiral, and two primary spiral endcaps extend all along, and axially outward beyond, the length of the primary spiral and the primary spiral housing.
14) Certain embodiments of section 13 above, wherein each of the primary spiral endcaps is adapted to connect to an end of the primary spiral and also adapted to connect to an end of the primary spiral housing.
15) Certain embodiments of section 14 above, wherein the connections to the primary spiral and to the primary housing are adapted to tighten the spiral and to latch/lock the spiral in the tightened condition by a method consisting of or consisting essentially of a user grasping (by hand or tool) the endcaps and rotating them relative to each other in opposite directions.
16) Certain embodiments of any of the numbered sections above, wherein the neutral wires/shield of the left cable are not in direct contact with the neutral wires/shield of the right cable, and the secondary spiral is in direct contact with the neutral wires/shield of both cables.
17) Certain embodiments of any of the numbered sections above, wherein the splice device does not include any bolts or set screws that are forced against the conductors (for example, not including bolts forced against the conductors such as in known prior art devices).
18) Certain embodiments of any of the numbered sections above, wherein the splice device does not include any shielding mesh, or wrapping/application of shielding mesh, during installation (for example, not including these items/methods that are used in known prior art devices).
19) Certain embodiments of any of the numbered sections above, wherein the splice device and associated methods do not include ejection of carrier tubes (for example, not including carrier tube/methods that are used in known prior art devices).
20) Certain embodiments of any of the numbered sections above, wherein the splice device is installed to splice the two cables in less than 20 minutes from start to finished splice.
21) Certain embodiments of any of the numbered sections above, wherein the splice device is installed to splice the two cables in 10-20 minutes from start to finished splice.
22) Certain embodiments of any of the numbered sections above, wherein one or more of the spirals/spiral portions of the spiral device comprises features and/or operation of Applicant's spiral technology as described in any of U.S. Pat. Nos. 7,794,255, 7,901,233, 8,066,525, 8,246,370, 8,771,000, and/or 9614304.
23) Certain Embodiments comprise a method of installing a splice device on two electrical cables, comprising:
providing a splice device comprising a tubular primary splice assembly and a tubular secondary splice assembly;
sliding the secondary splice assembly onto a first one of the two cables, inserting the conductors of the two cables into open ends of the primary splice assembly, and then tightening a primary spiral of the primary splice assembly by twisting endcaps of the primary splice assembly in opposite directions to twist the primary spiral ends in opposite directions to tighten the primary spiral around the conductors; and then sliding the secondary splice assembly over the primary splice assembly and twisting endcaps of the secondary splice assembly so a secondary spiral of the secondary splice assembly tightens around neutrals of the two cables.
24) Certain embodiments comprise the method of section number 23 above, wherein the method step of sliding the secondary splice assembly onto said first one of the cables comprises first removing a first sealing cap from the secondary splice assembly and sliding the sealing cap onto a second of the two cables, prior to tightening the primary spiral to perform the primary splice with the primary splice assembly, and then, after performing the primary splice, sliding the first sealing cap toward the primary splice and installing the first sealing cap on the secondary splice assembly that has been slid over said second of the two cables.
25) Certain embodiments comprise the method of section number 24 above, wherein the secondary splice assembly has a second sealing cap, and wherein, after the secondary splice assembly is slid toward and over the primary splice assembly, the second sealing cap is tightened to seal the splice device against said first one of the two cables.

Although this disclosed technology has been described above, and in the Drawings and Appendix, with reference to particular means, materials, and embodiments, it is to be understood that the disclosed technology is not limited to these disclosed particulars, but extends instead to all equivalents within the broad scope of the following claims.

1. A splice device for slicing a right and a left cable, each cable comprising an electrical conductor and a neutral, the splice device comprising:
a primary splice assembly having an axial passageway having a right opening and a left opening and receiving the conductor of the right cable in the right opening and receiving the left cable in the left opening, so that the primary splice assembly is coaxial with the cables and conductors;
the primary splice assembly comprising an electrically-conductive primary spiral around the axial passageway and the conductors that are received in the axial passageway, the spiral being tightenable around the conductors to compress the conductors to place the conductors of the right and left cables in electrical connection with the primary spiral so that the conductors of the two cables are in electrical connection with each other;
a secondary splice assembly that has a secondary passageway receiving the primary splice assembly, so that the secondary splice assembly is coaxial with the primary splice assembly and the cables, the secondary splice assembly having a secondary spiral inside the secondary passageway that has at least a right spiral portion and a left spiral portion that are tightenable to compress the neutrals of the cables, the secondary spiral being adapted to place the neutrals of the right and left cables in electrical connection/communication with the secondary spiral and with each other;
wherein said primary spiral has a length, and the primary splice assembly comprises a housing extending around the primary spiral, the housing having a length that is less than the primary spiral length, so that right and left ends of the primary spiral extend axially out from the housing to engage an endcap assembly comprising right and left endcaps,
wherein the endcap assembly extends all along the length of the housing and the length of the primary spiral, and connects to the housing by a ratcheting connection;
wherein rotating the right and left endcaps in opposite directions rotate right and left ends of the primary spiral to tighten the primary spiral around the conductors and the spiral is kept in tightened condition by the ratcheting connection of the endcaps to the housing; and
wherein said housing is rigid and formed of injection-molded semi-conductive material so the housing is a semi-conductive layer between the primary spiral and the endcaps.

2. The splice device of claim 1, wherein the housing extends along 80-98% of the length of the primary spiral so that ends of the spiral extend axially out past the housing to engage the endcaps.

3. The splice device as in claim 1 further comprising sealing components provided in the secondary splice assembly for sealing ends of the secondary splice assembly against the two cables for making the splice device waterproof so that water, moisture, and air/gasses do not enter into the interior cavity of the splice device.

4. The splice device as in claim 1 comprising a port through an outer housing of the secondary splice assembly through which epoxy is injected to form waterproofing for the interior of the splice device.

5. The splice device as in claim 1 comprising a RFID device on the outer surface of the splice device for monitoring device location and condition.

6. The splice device as in claim 1, wherein the housing of the primary splice assembly is rigid and formed of injection-molded semi-conductive material/plastic and so perform a mechanical operation in tightening the primary spiral and also a semiconductive operation to eliminate stress concentration points.

7. The splice device as in claim 1, wherein the endcaps of the primary splice assembly are rigid and formed of injection-molded semi-conductive material/plastic and so perform a mechanical operation in tightening the primary spiral and also a semiconductive operation to eliminate stress concentration points.

8. The splice device as in claim 1, wherein the splice device does not comprise tape wrapping around the conductors.

9. The splice device as in claim 6, wherein the splice device does not comprise tape wrapping around the conductors.

10. The splice device as in claim 7, wherein the splice device does not comprise tape wrapping around the conductors.

11. The splice device as in claim 1, wherein the splice device does not comprise tape wrapping around the neutrals.

12. The splice device as in claim 6, wherein the splice device does not comprise tape wrapping around the neutrals.

13. The splice device as in claim 7, wherein the splice device does not comprise tape wrapping around the neutrals.

14. The splice device as in claim 1, wherein a primary spiral housing extends along a substantial, but not the entire, length of the primary spiral, and two primary spiral endcaps extend all along, and axially outward beyond, the length of the primary spiral and the primary spiral housing.

15. The splice device as in claim 1, wherein the neutrals of the left cable and the right cable are axially spaced apart inside the splice device, so that the neutrals of the left cable are not in direct contact with the neutrals of the right cable, and the secondary spiral is in direct contact with the neutrals of both cables.

16. The splice device as in claim 1 that does not comprise any bolts or set screws forced against the conductors.

17. The splice device as in claim 1 that does not comprise shielding mesh.

18. The splice device as in claim 1, wherein the secondary spiral comprises a central portion between the right spiral portion and the left spiral portion that does not comprise spiral cuts.

19. The splice device as in claim 18, wherein the primary spiral comprises spiral cuts along at least 75% of the primary spiral length.

20. The splice device as in claim 1, wherein primary spiral hooks, on ends of the primary spiral, lock into the endcap assembly by receiving interior protrusions of the endcap assembly, and secondary spiral hooks, on ends of the secondary spiral, lock into secondary endcaps by receiving interior protrusions of the second endcaps.
